(19) United States
(12) Patent Application Publication
(10) Pub. No.: US 2013/0111747 A1
(43) Pub. Date: May 9, 2013

(54) Soldering Method for Producing an Electrically Conductive Connection

(71) Applicant: Robert Bosch GmbH, Stuttgart (DE)

(72) Inventor: Emil Hanauer, Abtswind (DE)

(73) Assignee: Robert Bosch GmbH, Stuttgart (DE)

(21) Appl. No.: 13/666,728

(22) Filed: Nov. 1, 2012

(30) Foreign Application Priority Data
Nov. 5, 2011 (DE) 10 2011 117 757.8

(51) Int. Cl. H01R 43/16

(52) U.S. Cl. 29/874

(57) ABSTRACT

A soldering method for producing an electrically conductive connection to heat-sensitive components includes soldering a contact lug onto a pole of the electrical component with a laser beam. The soldering method includes applying the contact lug and the pole to one another, wherein the contact lug comprises, at least on a surface, a material which has a lower melting point than a material of the pole and can serve as a solder. The soldering method also includes punctiformly heating the contact lug with a laser beam. The heating with the laser, the melting on of the solder and the subsequent conduction away of heat through the core material of the contact lug is carried out more quickly than the further input of heat into the interior of the component through the pole.

This application claims priority under 35 U.S.C. §119 to patent application no. DE 10 2011 117 757.8, filed on Nov. 5, 2011 in Germany, the disclosure of which is incorporated herein by reference in its entirety.

### BACKGROUND

The disclosure relates to a soldering method for producing an electrically conductive connection which method can be used, in particular, with heat-sensitive electrical components.

Electrically conductive connections are generally produced by screwing, soldering, pressing or welding. In contrast to screwing and pressing, soldering and welding results in heat which is transmitted to parts which are in contact with the electrically conductive connection.

Both soldering and welding are materially joined connections. They are related to one another and can be considered together. In both methods, a substance is melted on by heat and then connects two previously separate parts to one another. The strength of the connection is determined, on the one hand, by the basic material of the parts, but, on the other hand, by the connecting substance. The connecting substance can originate either from one of the parts or from both parts, but it can also be introduced as an additional material between the parts.

It is customary to connect capacitors and accumulators to one another by means of contact lugs, or to solder them onto printed circuit boards in electronic devices. In this context, the contact lugs are welded or soldered to the poles of the capacitors or accumulators. The problem with welding or soldering the poles is, however, that accumulators and also specific capacitors contain an electrolyte which has a boiling temperature or decomposition temperature which is usually lower than the temperature required when welding or soldering the connection to the poles. The contact lugs therefore either have to be soldered or welded onto the poles before the electrolyte is filled in, or the process heat of the soldering or welding has to be so low that the electrolyte is not heated up too much.

Methods using laser welding have been developed for connecting capacitors to contact lugs only after their fabrication. In these methods, rapid heating of the material generates only a small amount of overall process heat. The contact lugs are plugged onto the poles with a tight fit, and the gap is then welded to a laser. The material which is melted on in the process (referred to as the welding bath) may only be a fraction of the component thickness herein to prevent the heating from damaging the electrolyte which is adjacent underneath. A problem here is, however, focusing the laser precisely on the gap.

DE 10 2006 005 532 solves the problem of focusing the laser by means of a terminal pole which is covered completely by the contact lug and is then melted onto the contact lug through said lug. However, this solution entails even more material having to be melted on than in just a gap. As a result, overall even more process heat has to be generated than in the methods described above.

Another problem in the case of laser welding is that housings of capacitors are generally manufactured from aluminum which has a melting point of 660° C. In the case of laser welding, for process reasons the contact lugs also have to be fabricated from pure aluminum. However, such contact lugs require the contact lugs also to be melted on at the temperature of 660° C. The necessary process heat puts the electrolyte at risk.

In addition, such contact lugs made of pure aluminum are less customary in the market and are therefore more expensive than contact lugs which are customary in the market and are usually made of copper.

The object of the present disclosure is therefore to provide an improved soldering method for producing an electrically conductive connection, in which method in particular not only is there no need to focus on a gap, but also a large input of heat is avoided, with the result that said method can be used in particular in the case of heat-sensitive electrical components.

This object is achieved by a soldering method for producing an electrically conductive connection according to the description below.

Further advantageous refinements of the soldering method are specified in the description below.

### SUMMARY

With the specified soldering method, overall not only is less process heat required than in conventional methods, but the thermal flux is also optimized, in terms of the sequencing of the process, in order to protect the electrical component, in particular its electrolyte, under aluminum in the case of an electrical capacitor or a battery, which is advantageous, in particular, for heat-sensitive electrical components.

Furthermore, the costly focusing of a laser beam on a small gap, which is necessary in the prior art, is eliminated. As a result, the described soldering method is less time consuming and also more cost-effective. It is possible to use simpler and therefore more favorable devices for manufacturing an electrically conductive connection.

Furthermore, in the previously mentioned soldering method, commercially available contact lugs made of tin-plated copper can be used. The contact lugs only have to be laid in a planar fashion or flat on the pole of an electrical component, such as a battery, an accumulator or a capacitor etc., and do not have to be shaped specially to correspond to the terminal pole of the electrical component and have tolerances in its dimensions. This reduces the costs for the contact lugs to be used. In addition this simplifies the production of the electrically conductive connection and in turn reduces the costs for producing the electrically conductive connection.

Further possible implementations of the disclosure also comprise combinations, which are not explicitly specified, of features of embodiments which are described above or below with respect to the exemplary embodiments. In this context a person skilled in the art will also add individual aspects as improvements or supplements to the respective basic form of the disclosure.

### BRIEF DESCRIPTION OF THE DRAWINGS

The disclosure will be described in more detail below with reference to the appended drawing and on the basis of exemplary embodiments.

In the drawing:

FIG. 1 shows a side view of an electrical component which is connected to a contact lug by means of an electrically conductive connection which is produced with a soldering method for producing an electrically conductive connection according to an exemplary embodiment;

FIG. 2 shows a plan view of the electrical component which is shown in FIG. 1 and which is connected to the contact lug via the electrically conductive connection;

FIG. 3 shows a partial sectional view of the electrical component, as shown in FIG. 1, and of the contact lug which are connected via the electrically conductive connection;

FIG. 4 shows a flow chart of a soldering method for producing an electrically conductive connection according to the exemplary embodiment; and

FIG. 5 shows a flow chart of a soldering method for producing an electrically conductive connection according to a modification of the exemplary embodiment.

Identical or functionally identical elements are provided with the same reference symbols in the figures, unless specified otherwise.

### DETAILED DESCRIPTION

FIG. 1 shows an electrical component 1 which can be a capacitor, a battery, in particular an accumulator etc. In FIG. 1, the electrical component 1 is a capacitor. The electrical component has two poles 11, 12 which are connected to electrodes (not illustrated) in the interior of the electrical component 1. The two poles 11, 12 lead out of the interior of the electrical component 1 to its exterior and serve as connections of the electrical component 1. The pole 11 is connected in an electrically conductive fashion to a contact lug 2 which bears against the pole 11. In addition, the pole 12 is connected in an electrically conductive fashion to a contact lug 3 which bears against the pole 12. In order to produce an electrically conductive connection between the poles 11, 12 and the respective contact lugs 2, 3, a laser beam 5 which is emitted by a laser 4 is used.

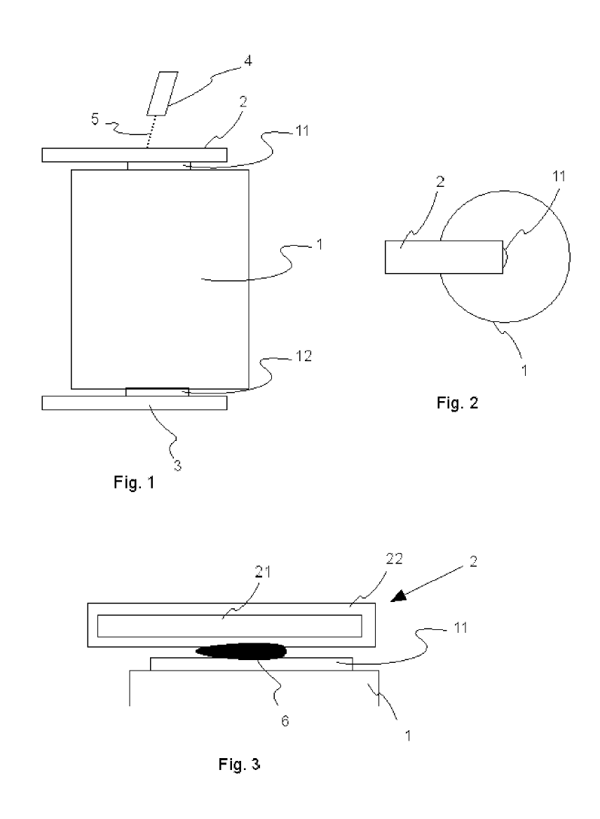

FIG. 2 shows the electrical component 1 of FIG. 1 with its pole 11 and the contact lug 2 from above. The contact lug 2 lies in FIG. 2 in a planar fashion, or in other words flat, on the pole 11, which has a circular circumference like the electrical component 1. In FIG. 2, the contact lug 2 is a planar plate, while the pole 11 is embodied as a circular disk which is also planar.

FIG. 3 shows the electrically conductive connection 6 between the pole 11 and the contact lug 2 in a schematic view. The contact lug 2 is fabricated from tin-plated copper. That is to say the contact lug 2 has a core 21 made of copper which is coated on the outside with a layer of tin 22. The melting point of tin is approximately 232° C. The melting point of copper is approximately 1084° C. In contrast, the poles 11, 12 are fabricated from aluminum whose melting point is approximately 660° C. The contact lug 2 therefore has, at least on the surface, a material which has a lower melting point than the material of the pole 11.

In order to produce the electrically conductive connection 6, the contact lug 2 is heated briefly on its side facing away from the pole 11 with the laser 4, as illustrated in FIG. 1. The heat flows very quickly through the core 21 made of copper to the layer of tin 22 in front of the pole 11 made of aluminum. Heat can only flow into the pole 11 made of aluminum to a relatively large extent when the layer of tin 22 has melted on and has produced the soldered connection, that is to say the electrically conductive connection 6, to the pole 11 made of aluminum. However, the heat will then also already be conducted away again into the contact lug 2 which extends onward, to be more precise its core 21 made of copper. As a result, the production of the electrically conductive connection 6 cannot lead to damage in the interior of the electrical component 1, in particular its electrolyte.

Heated briefly means in this case that the surface of the contact lug 2 is heated above the melting temperature of its material only for as long as is required to generate a soldering point on the pole 11. It is therefore sufficient to heat the contact lugs 2, 3 only briefly above the melting temperature of tin, which is located on the surface of the contact lugs 2, 3, and also to do this only in a punctiform fashion in order to generate a soldering point on the respective pole 11, 12 which is fabricated from aluminum. For this purpose, the contact lug 2 is, as is shown in FIG. 1, heated in a punctiform fashion on its side facing away from the pole 11, with the laser 4. The point is preferably smaller than the entire surface on which the contact lug 2 and the pole 11 bear one against the other, as is also apparent from FIG. 3 from the size of the electrically conductive connection 6 compared to the contact lug 2 and the pole 11. The laser beam 5 of the laser 4 is well suited for such heating.

In order to increase the surface of the soldered connection, the application of the laser beam after the cooling of the laser point can also be repeated frequently and in the local vicinity. The process heat is transported away relatively quickly through the core material of the contact lug.

In the described method, a soldering method, only the additional material is molten but alloys are formed in the boundary layer between the basic material and the additional material, which alloys also produce a materially joined connection between the parts. The additional material during the soldering, here tin, has a significantly lower melting point than the basic materials, here aluminum and copper, for which reason less thermal energy has to be applied. This is a large advantage over the previously described welding in which the basic material of the parts (contact lug, pole) is also melted on. For this reason, in the case of welding more thermal energy has to be applied than in the case of soldering, which energy is then also introduced into the parts.

The contact lug 3 is of exactly the same construction as the contact lug 2, and therefore reference is made to the preceding description with respect to the configuration of said contact lug 2 and the production of an electrically conductive connection 6 to the pole 12.

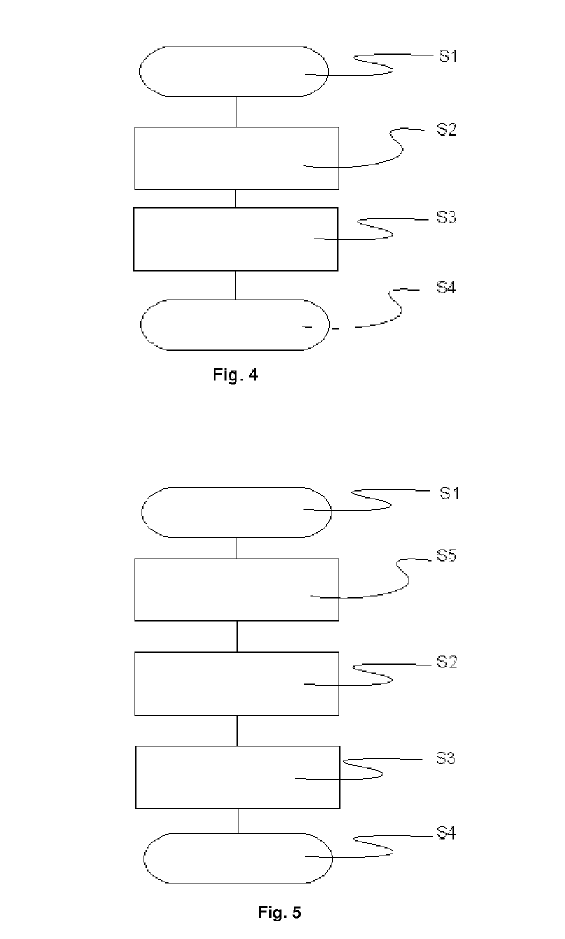

FIG. 4 shows the previously described soldering method for producing the electrically conductive connection 6 in an overview. After the start of the soldering method in step S1, the contact lug 2 and the pole 11 of the electrical component 1 are applied to one another in step S2. In this context, the contact lug 2 has, at least on the surface, as previously described, a material which has a lower melting point than the material of the pole. In step S3, the contact lug 2 is heated in a punctiform fashion by means of the laser beam 5 of the laser 4, as previously described.

FIG. 5 shows a modification of the soldering method shown in FIG. 4. In addition to the steps S1 to S4 of the soldering method according to the exemplary embodiment, the soldering method according to the modification of the exemplary embodiment has a step S5 in which the surface of the contact lug 2, which faces the pole 11 after the step of application to one another, is wetted with a flux for better solderability. As an alternative to, or in addition to, the specified surface of the contact lug 2, the surface of the pole 11, which faces the contact lug 2 after the step of application to one another, can also be wetted with the flux for better solderability. The flux can also include additional soldering material.

Step S5 takes place before the step S4 of punctiform heating, as is illustrated in FIG. 5. In addition it is advantageous if step S5 also takes place before the step S2 of application of the contact lug 2 and pole 11 or contact lug 3 and pole 12 to one another, since in this case no consideration has to be given to the geometry of the structure composed of the contact lug and the pole which have been applied to one another, and the electrical component 1 cannot be soiled with the flux.

With the soldering method and its modification described above it is possible to avoid both the problem of the focusing onto a gap and a large input of heat. A contact lug is placed on top of the pole in a planar fashion and then heated with a laser beam in a punctiform fashion.

All the previously described refinements of the soldering method can be used individually or in any possible combinations. In addition, in particular the following modifications are conceivable.

The parts illustrated in the figures are illustrated schematically, and in the precise configuration they can deviate from the shapes shown in the figures as long as their functions described above are ensured.

For example the shape of the contact lugs 2, 3 and the pole 11, 12 do not have to be specifically matched to one another. The contact lug 2 and the pole 11 or the contact lug 3 and the pole 12 must, however, be able to contact one another in order to be able to produce the conductive connection 6 with the soldering method described.

The number of poles 11, 12 and the contact lugs 2, 3 can be selected according to requirements. It is possible to use, in particular, more or fewer than the poles 11, 12 and/or contact lugs 2, 3 shown in the figures.

The contact lugs 2, 3 are preferably provided with a thicker layer of tin 22 than is customary in the market. A thickness according to EN 13148 of approximately 10 μm is customary in the market, but it is also possible to produce thicker layers. As a result, a soldered connection can be more reliably produced.

Although it is also possible for step S5 to take place before the punctiform heating step S3, but to be carried out after the step S2 of the application of the contact lug 2 and pole 11, or of the contact lug 3 and pole 12, to one another.

The laser 4 can either emit a continuous or a pulsed laser beam and can be, in particular an ND-Yag laser.

What is claimed is:

1. A soldering method for producing an electrically conductive connection by soldering a contact lug onto an electrical component comprising:
applying the contact lug to a pole of the electrical component, wherein:
the contact lug comprises, at least on a surface, a first material having a lower melting point than a second material of the pole; and
the contact lug is punctiformly heated with a laser beam.

2. The soldering method according to claim 1, wherein:
the contact lug and the pole are placed on top of one another in a planar fashion during application.

3. The soldering method according to claim 1, wherein:
the contact lug is heated only briefly above a melting point of the first material during punctiform heating.

4. The soldering method according to claim 3, wherein:
the contact lug is fabricated from tin-plated copper; and
the contact lug is heated only briefly above the melting point of tin during punctiform heating.

5. The soldering method according to claim 1, wherein:
the contact lug is heated on a side facing away from the pole during punctiform heating.

6. The soldering method according to claim 1, wherein:
a pulsed laser beam is used during punctiform heating.

7. The soldering method according to claim 1, further comprising, before punctiform heating, at least one of:
wetting with a flux configured to improve solderability a surface of the contact lug which faces the pole after the application of the contact lug; and
wetting with a flux configured to improve solderability a surface of the pole which faces the contact lug after the application of the contact lug.

8. The soldering method according to claim 7, wherein the flux comprises additional soldering material.
